(19) United States
(12) Patent Application Publication
(10) Pub. No.: US 2005/0114853 A1
(43) Pub. Date: May 26, 2005

(54) Software upgrade and downgrade in systems with persistent data

(76) Inventors: Joseph S. Glider, (US); Archana S. Samtani, (US)

Correspondence Address: Frederick W. Gibb, III;McGinn & Gibb, PLLC, Suite 304, 2568-A Riva Road, Annapolis, MD, 21401, US

(21) Appl. No.: 10/723,085

(22) Filed: Nov. 26, 2003

(51) Int. Cl. G06F 9/44; G06F 9/445

(52) U.S. Cl. 717/170; 717/175

(57) ABSTRACT

Disclosed is a system, method, and program storage device implanting the method for revising a software application wherein the software application utilizes persistent data, comprising applying an upgrade to a first next level of software that understands both old and new persistent data structure formats; converting all persistent data structures into the old persistent data structure format; applying an upgrade to a second next level of software that understands the old and new persistent data structure formats; converting all persistent data structures into the new persistent data structure format; applying a downgrade to a first previous level of software that understands both the old and new persistent data structure formats; converting all persistent data structures into the old persistent data structure format; and applying a downgrade to a second previous level of software that understands the old persistent data structure formats.

### BACKGROUND OF THE INVENTION

1. Field of the Invention

The invention generally relates to software programming and software revisions, and more particularly to software upgrades/downgrades from version to version.

2. Description of the Related Art

Software applications often exhibit a high level of complexity. Nevertheless, they must be constantly adapted to the newest standards and must be updated with new features. Once the application has been upgraded (i.e., an older version has been replaced with a newer version), users must have the ability to backtrack for business or technical reasons. For example, if the newer software version is incompatible with the hardware or software environment, the user may prefer to use the older software version. Another example is if the newer software version is being used on a trial basis or as a pre-production test and it must be backed out until a license has been bought. Yet another reason is if the software upgrade fails and has to be backed out. Therefore, software application users must also have the flexibility to downgrade (i.e., replace a newer version with an older version) their software systems to previous versions of the software.

The upgrade/downgrade process often involves changing parts of the software system by updating/downgrading program data structures, procedures, algorithms, etc. The data used or managed by the application may be either transient or non-volatile. Transient data is data that does not have to be recoverable in the event of a failure or power loss, whereas non-volatile data (e.g., system configuration information, system state information) stored in memory must be retained across power loss and failures as well as from one upgrade or downgrade from one software version to the next. Not only must the information be recoverable, but it can also be dynamic both in the space requirements and the structures. Thus, if software developers want to allow for both an upgrade and a downgrade, the updated software must be compatible with the previous software version so that dynamic non-volatile data can be understood and processed by both versions (old and new) of the software.

In a distribution processing environment there is an additional implication of software upgrades and downgrades. In order to complete its task, applications for distributed systems often require communication between the different entities that comprise the system. Communication takes place by entities sending packets of information to each other where the information within the packets has a specific structure. These software applications on different entities must be updated from time to time to adapt to newer standards, correct software errors and provide new features. An implication of an update might be that the communication packet structures are altered to satisfy new requirements or provide new functions. In addition, sequences of communication packets between entities might also change. However, it may not be possible to update the software application on all of the entities in a system at once. Moreover, it is desirable that the distributed system as a whole continues to provide service without any disruptions. As a result, these entities must continue to interoperate as per their specified behavior, although they may be running different software versions. In other words, communication packets and sequences of communication packets between distributed nodes (i.e., entities) must be compatible when the software of only a subset of the nodes has been updated (i.e., a communication packet from one entity must be readable and understandable by another entity even when that entity is at a more or less recent software version than the other).

Some systems allow concurrent code upgrade only when no persistent data structures (i.e., non-volatile memory structures or communication packet structures) are changed, otherwise a disruptive upgrade is required. A disruptive upgrade means that some downtime is introduced, which makes the system unavailable for that amount of time. The upgrades involve shutting down the system, taking it offline, applying the upgrade procedure, rebooting the system and restarting the application.

There are conventional mechanisms for software upgrades for real-time systems where downtime is minimized or avoided. For example, for the purpose of an upgrade, the processor is divided into two logical partitions. The old software version runs in one partition while the new version is started and verified in the other partition. If data exists such that the data structure differs between the old and the new version, the data is transformed from the old representation to the new representation and transferred to the new software. New transactions are handled by the new version and transactions in progress on the old version are completed, forced to terminate, or transferred to the new version of the software for continued processing.

Unfortunately, the conventional methods do not allow for software downgrades. Moreover, the conventional methods do not provide techniques in situations when software upgrades and downgrades must be performed in the presence of persistent data structures. Therefore, due to the limitations of the conventional software upgrade systems and methods; there remains a need for a new software revision technique, which allows both software upgrades and downgrades to be performed in the presence of persistent data.

### SUMMARY OF THE INVENTION

In view of the foregoing, an embodiment of the invention provides a method for revising a software application wherein the software application utilizes persistent data, wherein the method comprises applying an upgrade to a first next level of software that understands both old and new persistent data structure formats; converting all persistent data structures into the old persistent data structure format; applying an upgrade to a second next level of software that understands the old and new persistent data structure formats; converting all persistent data structures into the new persistent data structure format; applying a downgrade to a first previous level of software that understands both the old and new persistent data structure formats; converting all persistent data structures into the old persistent data structure format; and applying a downgrade to a second previous level of software that understands the old persistent data structure formats. Moreover, the persistent data structures also include communication packet structures. Also, the software application can be a distributed system software application, which comprises a plurality of nodes each including non-volatile memory data structures, wherein the nodes communicate with one another. Additionally, the communication between the nodes occurs using the communication packet structures.

The invention is preferably used in situations where software upgrades and downgrades must be performed in the presence of persistent data. Furthermore, the invention allows upgrading or downgrading the software system from one version to another subsequently released version that is one version above or below the current version.

In another embodiment, the invention provides a program storage device for implementing the method and a system for providing updates to a software application wherein the software application utilizes persistent data, wherein the system comprises a first module operable for applying an upgrade to a first next level of software that understands both old and new persistent data structure formats; a first converter in the first module operable for converting all persistent data structures into the old persistent data structure format; a second module operable for applying an upgrade to a second next level of software that understands the old and new persistent data structure formats; a second converter in the second module operable for converting all persistent data structures into the new persistent data structure format; a third module operable for applying a downgrade to a first previous level of software that understands both the old and new persistent data structure formats; a third converter in the third module operable for converting all persistent data structures into the old persistent data structure format; and a fourth module operable for applying a downgrade to a second previous level of software that understands the old persistent data structure formats.

There are several advantages of the invention. For example, the invention can be used for the software upgrade and downgrade of any application that has persistent data. Moreover, the invention provides a simple and flexible non-disruptive method for allowing software updates. The invention also works well in a distributed environment since it enables nodes temporarily operating at different software levels to communicate with each other. Finally, as indicated above, a benefit of the invention is to provide a method of software upgrade that not only allows non-disruptive upgrades on systems with persistent data but also allows subsequent non-disruptive downgrades on systems with persistent data.

These, and other aspects and advantages of the invention will be better appreciated and understood when considered in conjunction with the following description and the accompanying drawings. It should be understood, however, that the following description, while indicating preferred embodiments of the invention and numerous specific details thereof, is given by way of illustration and not of limitation. Many changes and modifications may be made within the scope of the invention without departing from the spirit thereof, and the invention includes all such modifications.

### BRIEF DESCRIPTIONS OF THE DRAWINGS

The invention will be better understood from the following detailed description with reference to the drawings, in which:

FIG. 1 is a system diagram illustrating independent nodes in a distributed system environment attached to a network according to an embodiment of the invention;

FIG. 2 is a system diagram illustrating independent nodes in a distributed system environment holding persistent data in memory according to an embodiment of the invention;

FIG. 3 is a system diagram illustrating the communication in a distributed system environment according to an embodiment of the invention;

FIG. 4 is a flow diagram illustrating a preferred method of the invention;

FIG. 5 is a flow diagram illustrating a preferred method of the invention;

FIG. 6(a) is a schematic diagram illustrating an embodiment of the invention;

FIG. 6(b) is a schematic diagram illustrating an embodiment of the invention;

FIG. 6(c) is a schematic diagram illustrating an embodiment of the invention;

FIG. 6(d) is a schematic diagram illustrating an embodiment of the invention;

FIG. 7 is a system diagram according to an embodiment of the invention; and

FIG. 8 is a system diagram according to an embodiment of the invention.

### DETAILED DESCRIPTION OF PREFERRED EMBODIMENTS OF THE INVENTION

The invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the invention. The examples used herein are intended merely to facilitate an understanding of ways in which the invention may be practiced and to further enable those of skill in the art to practice the invention. Accordingly, the examples should not be construed as limiting the scope of the invention.

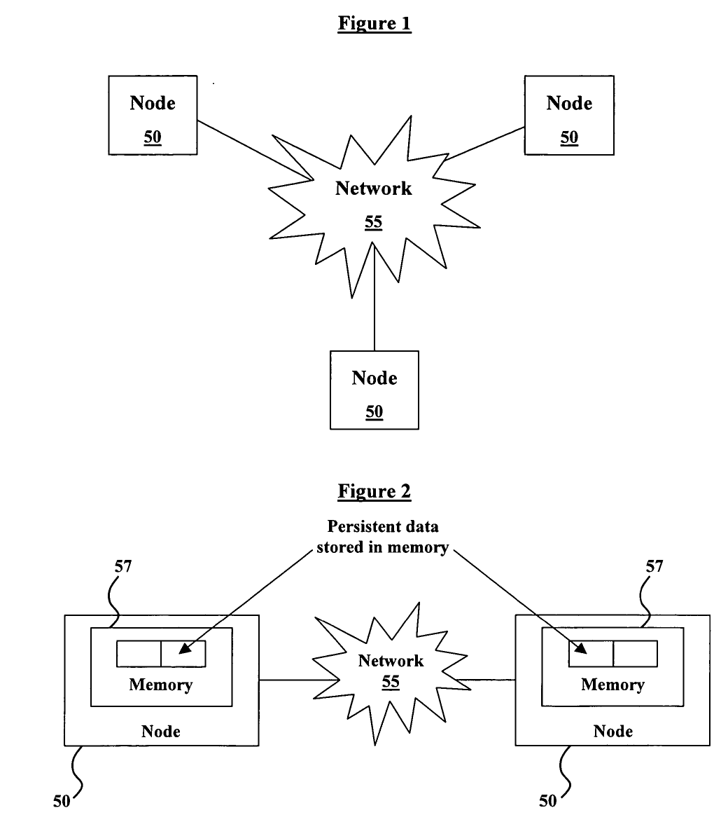

As mentioned, there is a need for a new software revision technique, which allows both software upgrades and downgrades to be performed in the presence of persistent data. Referring now to the drawings and more particularly to FIGS. 1 through 8, there are shown preferred embodiments of the invention. According to the invention, a distributed computer software application is embodied as a series of nodes running a distributed software application. Each node represents an independent processor with memory and network connections that enable it to communicate with other nodes such that the collection of nodes connected together by a network cooperate to achieve a common goal.

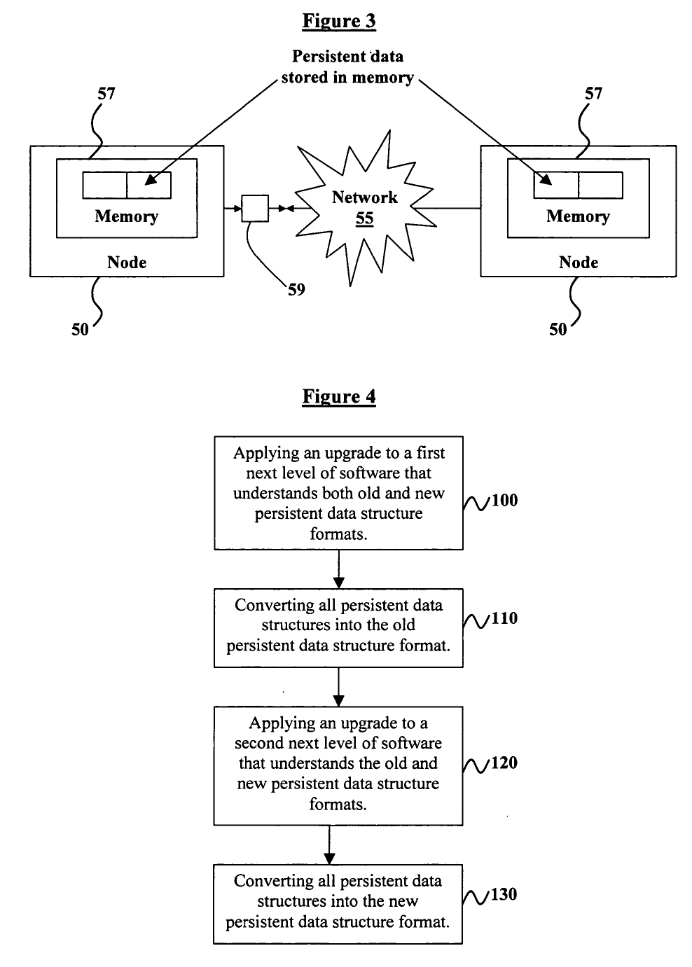

FIG. 1 shows a system, in accordance with the invention, with independent nodes 50 attached to a network 55. FIG. 2 shows the system with independent nodes 50 having memory 57 and connected together by the network 55. Moreover, FIG. 2 shows the nodes 50 holding persistent data inside the memory 57. In this environment, software can be upgraded and downgraded in accordance with the invention. FIG. 3 once again shows the elements of FIG. 2, and additionally shows that communication takes place by nodes 50 sending packets 59 of information to each other. In this environment software can be upgraded and downgraded in accordance with the invention.

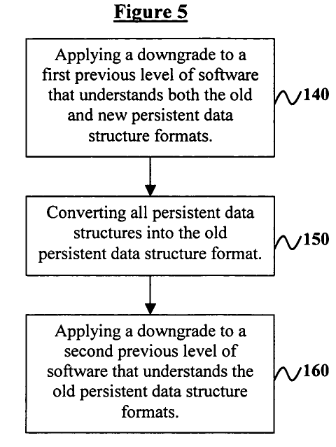

The flowchart of FIG. 4 illustrates a method for revising a software application wherein the software application utilizes persistent data, wherein the method comprises applying 100 an upgrade to a first next level of software that understands both old and new persistent data structure formats; converting 110 all persistent data structures into the old persistent data structure format; applying 120 an upgrade to a second next level of software that understands the old and new persistent data structure formats; and converting 130 all persistent data structures into the new persistent data structure format. The flowchart of FIG. 5 illustrates that the method further comprises applying 140 a downgrade to a first previous level of software that understands both the old and new persistent data structure formats; converting 150 all persistent data structures into the old persistent data structure format; and applying 160 a downgrade to a second previous level of software that understands the old persistent data structure formats. Moreover, the persistent data structures include communication packet structures. Also, the software application may comprise a distributed system software application, which further comprises a plurality of nodes including non-volatile memory data structures, wherein the nodes communicate with one another. Additionally, the communication between the nodes occurs using the communication packet structures.

The invention allows a software upgrade (to a newer version of the software) or downgrade (to an older version of the software) to be performed on any node, whereby the software versions include persistent data structure formats, communication packet structure formats and/or sequences of communication packets that are different from the existing version. The invention includes the following characteristics. First, the invention makes it possible to apply software upgrades and downgrades without disruption of the communication between the nodes in a distributed system even though the nodes may be temporarily operating with different software levels. As long as any two nodes have a single level difference in their software versions, both nodes will be able to follow a common communication protocol by detecting a different level of packet structure or protocol and using a conversion step at one or both of the nodes to transform the packet structure or protocol as appropriate.

Second, persistent information is preserved through the software upgrade and downgrade even if the information structure and size changes as part of that upgrade or downgrade. The upgrade process ensures that the persistent information is converted from its old format to its new format; i.e., the format that is understood by the new software version. Therefore, the information is preserved correctly and can be used by the new software version as intended. The downgrade process ensures that the persistent information is converted from its new format to its old format; i.e., the format that is understood by the old software version. Therefore, the information is preserved and can be used by the old software version as intended. One of the benefits of the invention is that it provides a method of upgrading software non-disruptively that not only works on systems that include persistent data, but also allows non-disruptive software downgrade on such systems.

More specifically, the invention comprises three elements: software upgrades, software downgrades, and remote communication between the nodes. Software upgrades involving changes of persistent data structure formats, communication packets and protocols are broken down into two levels of new software that are to be applied in sequence. Both levels of new software are aware of the old and new persistent data structure formats, communication packets, and protocols. The following steps describe an example by which the method occurs for software upgrade, software downgrade, and remote communication between nodes with different code loads.

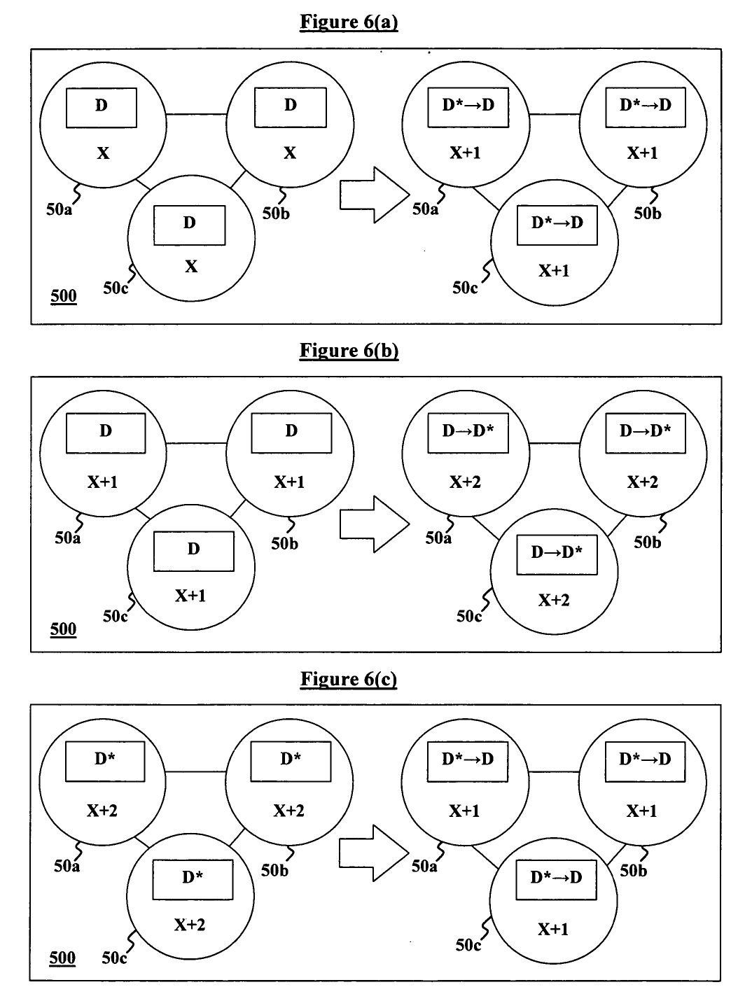

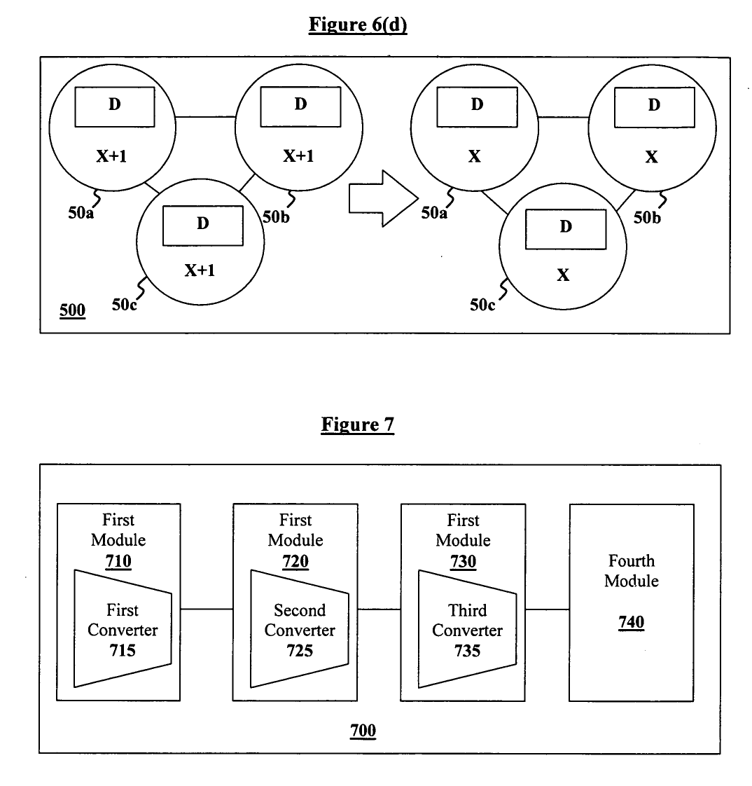

FIGS. 6(a) and 6(b) illustrate the software upgrade technique according to the invention. In this example, it is assumed that there are three nodes 50a, 50b, 50c, represented as circles in the various figures, with the distributed application using the existing (old) software version X. During the software revision process, it is determined that an update to the software application is needed such that the persistent structure with format D must be modified resulting in new data structure format D*. The software upgrade is applied on each node 50a, 50b, 50c sequentially one node at a time, until all of the nodes 50a, 50b, 50c in the system 500 have been upgraded. The following basic steps describe the procedure required to handle the change of the persistent data structure.

The software upgrade level X+1 is first applied on a single node 50a as shown in FIG. 6(a). Here, persistent data that had been stored by software level X is retrieved. According to this example, the persistent data in version X is indicated as format D. The software level X+1 understands both data formats (D from existing version and D* in the new version) but in a conversion step converts all persistent data from the D* format to the D format. The data structures can now be used as the rest of the software at level X+1 expects format D. Thus, the persistent data will be stored in representation format D. Next, for both the other nodes 50b, 50c in the distributed system 500, the same steps described above are repeated one node at a time, to upgrade the entire system 500 to software level X+1.

Thereafter, there will be another level that uses format D* such that the software code expects format D* since during the software revision process it is determined that an update to the software is needed such that the persistent structure D located at each node 50a, 50b, 50c is modified resulting in persistent data structure D*. Then, as shown in FIG. 6(b), the invention applies a software upgrade to level X+2 on a single node 50a. Here, the persistent data that had been stored by software level X+1 is retrieved. As indicated above, this persistent data will be in format D. As software level X+2 understands both data formats (D and D*), it converts all persistent data from format D to format D*. The data structures can now be used as the rest of the software at level X+2 expects D*. Persistent data will be stored in representation format D*. Thereafter, for both the other nodes 50b, 50c in the distributed system 500, the above steps are repeated one node at a time to upgrade the overall system 500 to software level X+2. The two-step process provided by the invention is particularly beneficial because it allows a reversible process in the presence of errors on some nodes. An example of this is if the upgrade went directly from X to X+2 and some nodes didn't complete the transition to X+2, there would be no way to back down the software in the system from X+2 to X.

FIG. 6(c) and 6(d) illustrate the software downgrade technique according to the invention. Suppose the distributed application must be downgraded from software level X+2 to X, then the invention provides for the following sequence of steps to allow for this to happen. First, the invention applies software downgrade level X+1 sequentially to the nodes 50a, 50b, 50c as illustrated in FIG. 6(c). Here, persistent data that had been stored by software level X+2 is retrieved. As indicated above, this persistent data will be in format D*. Moreover, software version X+1 understands both data formats but in a conversion step converts all structures from format D* to format D. As such, the data structures can now be used as the rest of the software at level X+1 expects format D. Thus, the persistent data will be stored in representation format D. This occurs first for node 50a, and then for both the other nodes 50b, 50c in the distributed system 500 the above steps are repeated one node at a time in order to downgrade the overall system 500 to software level X+1.

Thereafter, a software downgrade to level X is applied to the nodes 50a, 50b, 50c sequentially as depicted in FIG. 6(d). Here, the persistent data that had been stored by software level X+1 is retrieved. This will be in format D. Software level X understands data format D as indicated above, therefore, the data structures can now be used as the rest of the software at level X expects persistent data format D. Thus, the persistent data will remain in representation format D. Again, this occurs first in node 50a, and then for both of the remaining nodes 50b, 50c in the distributed system 500 the above steps are repeated one node at a time, to downgrade the overall system 500 back to software level X.

Next, with regard to communication between nodes. While upgrading the software version, it is possible to have two nodes temporarily operating with different software levels. For example, assuming a first node has software level X+1 and a second node has software level X+2, then the first node sends the second node a communication packet with format D. Here, software level X+2 on the second node understands both communication packet structures but in a conversion step converts the communication packet from format D to D*. Hence, the communication packet structures can now be used, as the rest of the software, which is at level X+2, expects format D*. If the second node has to send a response to the first node, it uses communication packet structure format D*. Software level X+1 on the first node understands both communication packet structures but in a conversion step converts the data from format D* to D. Again, the communication packet structures can now be used as the rest of the software, which is at level X+1, expects format D. In this way, the method enables nodes in the distributed system 500 to continue communicating with each other, even when the nodes operate at different software levels. Without this capability, inter-node communication would be stalled until all the nodes are updated with the same software level.

The method described above indicates that all nodes 50a at software level X+1 will be able to communicate with all other nodes 50b, 50c in the distributed environment using communication packet structure D. Moreover, all nodes 50a at level X+2 will be able to communicate with all other nodes 50b, 50c in the distributed environment using data or communication packet structure D*. Thus, even during the period of time that the distributed upgrade is occurring on multiple nodes, communication packets between different systems that may be at different levels can continue to flow and be understood, thereby allowing the system 500 to continue to operate

As mentioned, the invention provides a system 700 for providing revisions to a software application wherein the software application utilizes persistent data, wherein the system 700 comprises means for applying an upgrade to a first next level of software that understands both old and new persistent data structure formats; means for converting all persistent data structures into the old persistent data structure format; means for applying an upgrade to a second next level of software that understands the old and new persistent data structure formats; means for converting all persistent data structures into the new persistent data structure format; means for applying a downgrade to a first previous level of software that understands both the old and new persistent data structure formats; means for converting all persistent data structures into the old persistent data structure format; and means for applying a downgrade to a second previous level of software that understands the old persistent data structure formats.

For example, the above described system 700 may be embodied as illustrated in FIG. 7, wherein the system 700 for providing updates to a software application wherein the software application utilizes persistent data comprises a first module 710 operable for applying an upgrade to a first next level of software that understands both old and new persistent data structure formats; a first converter 715 in the first module 710 operable for converting all persistent data structures into the old persistent data structure format; a second module 720 operable for applying an upgrade to a second next level of software that understands the old and new persistent data structure formats; a second converter 725 in the second module 720 operable for converting all persistent data structures into the new persistent data structure format; a third module 730 operable for applying a downgrade to a first previous level of software that understands both the old and new persistent data structure formats; a third converter 735 in the third module 730 operable for converting all persistent data structures into the old persistent data structure format; and a fourth module 740 operable for applying a downgrade to a second previous level of software that understands the old persistent data structure formats.

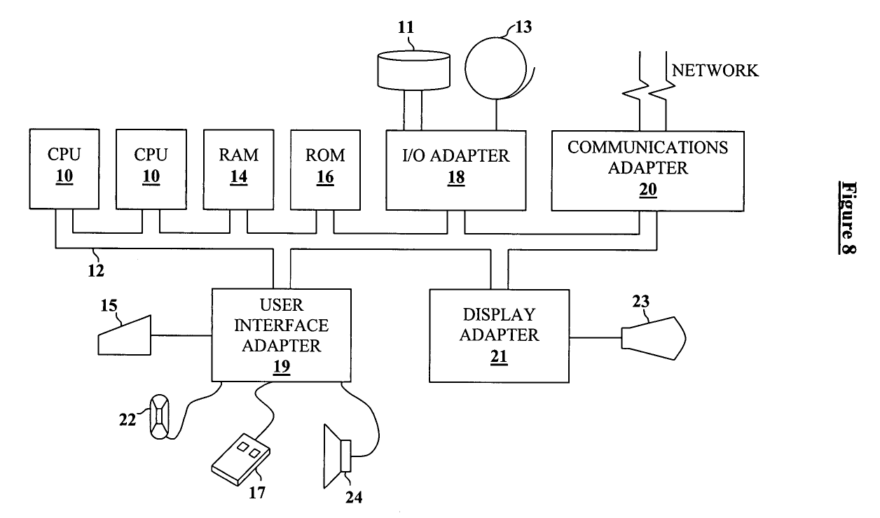

A representative hardware environment for practicing the present invention is depicted in FIG. 8, which illustrates a typical hardware configuration of an information handling/computer system in accordance with the invention, having at least one processor or central processing unit (CPU) 10. The CPUs 10 are interconnected via system bus 12 to random access memory (RAM) 14, read-only memory (ROM) 16, an input/output (I/O) adapter 18 for connecting peripheral devices, such as disk units 11 and tape drives 13, to bus 12, user interface adapter 19 for connecting keyboard 15, mouse 17, speaker 24, microphone 22, and/or other user interface devices such as a touch screen device (not shown) to bus 12, communication adapter 20 for connecting the information handling system to a data processing network, and display adapter 21 for connecting bus 12 to display device 23. A program storage device readable by the disk or tape units is used to load the instructions, which operate the invention, which is loaded onto the computer system.

The invention allows upgrades and downgrades (i.e., revisions or updates) in software applications, and more particularly in distributed software applications that have persistent data structures, in such a way as to allow subsequent downgrades of the software application while retaining the information and ability to use the information contained in the persistent data structures. The system and method provided by the invention comprise applying a first upgrade step, which understands both old and new persistent data structure formats, converts all persistent data structures into the old persistent data structure format and uses the persistent data structures in the old persistent data structure format, and then applying a second upgrade step, which understands the old and new persistent data structure formats, converts all persistent data structures into the new persistent data structure format and uses the persistent data in the new persistent data structure format. Thereafter, the invention performs a series of downgrade steps, which allows for the conversion from the newer version of software back to the older version. The persistent data structures comprise data structures held in non-volatile memory or in communication packets between entities in the distributed applications. Moreover, the distributed system software application comprises a plurality of nodes holding the non-volatile memory data structures or sending data structures to each other held in communication packets.

There are several advantages of the invention. For example, the invention can be used for the software upgrade and downgrade of any application that has persistent data. Moreover, the invention provides a simple and flexible non-disruptive method for allowing software updates. The invention also works well in a distributed environment since it enables nodes temporarily operating at different software levels to communicate with each other. Finally, as indicated above, a benefit of the invention is to provide a method of software upgrade that not only allows non-disruptive upgrades on systems with persistent data but also allows subsequent non-disruptive upgrades on systems with persistent data.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the invention can be practiced with modification within the spirit and scope of the appended claims.

1. A method for revising a software application wherein said software application utilizes persistent data, said method comprising:
applying an upgrade to a first next level of software that understands both old and new persistent data structure formats;
converting all persistent data structures into the old persistent data structure format;
applying an upgrade to a second next level of software that understands said old and new persistent data structure formats; and
converting all persistent data structures into the new persistent data structure format.

2. The method of claim 1, wherein said persistent data structures comprise communication packet structures.

3. The method of claim 2, wherein said software application comprises a distributed system software application including a plurality of nodes holding non-volatile memory data structures.

4. The method of claim 3, wherein said nodes communicate with one another.

5. The method of claim 4, wherein the communication between said nodes occurs using said communication packet structures.

6. The method of claim 1, further comprising:
applying a downgrade to a first previous level of software that understands both said old and new persistent data structure formats;
converting all persistent data structures into the old persistent data structure format; and
applying a downgrade to a second previous level of software that understands said old persistent data structure formats.

7. A system for providing updates to a software application wherein said software application utilizes persistent data, said system comprising:
a first module operable for applying an upgrade to a first next level of software that understands both old and new persistent data structure formats;
a first converter in said first module operable for converting all persistent data structures into the old persistent data structure format;
a second module operable for applying an upgrade to a second next level of software that understands said old and new persistent data structure formats; and
a second converter in said second module operable for converting all persistent data structures into the new persistent data structure format.

8. The system of claim 7, wherein said persistent data structures comprise communication packet structures.

9. The system of claim 8, wherein said software application comprises a distributed system software application including a plurality of nodes holding non-volatile memory data structures.

10. The system of claim 9, wherein said nodes communicate with one another.

11. The system of claim 10, wherein the communication between said nodes occurs using said communication packet structures.

12. The system of claim 7, further comprising:
a third module operable for applying a downgrade to a first previous level of software that understands both said old and new persistent data structure formats;
a third converter in said third module operable for converting all persistent data structures into the old persistent data structure format; and
a fourth module operable for applying a downgrade to a second previous level of software that understands said old persistent data structure formats.

13. A system for providing updates to a software application wherein said software application utilizes persistent data, said system comprising:
means for applying an upgrade to a first next level of software that understands both old and new persistent data structure formats;
means for converting all persistent data structures into the old persistent data structure format;
means for applying an upgrade to a second next level of software that understands said old and new persistent data structure formats; and
means for converting all persistent data structures into the new persistent data structure format.

14. The system of claim 13, further comprising:
means for applying a downgrade to a first previous level of software that understands both said old and new persistent data structure formats;
means for converting all persistent data structures into the old persistent data structure format; and
means for applying a downgrade to a second previous level of software that understands said old persistent data structure formats.

15. A program storage device readable by computer, tangibly embodying a program of instructions executable by said computer to perform a method for revising a software application wherein said software application utilizes persistent data, said method comprising:
applying an upgrade to a first next level of software that understands both old and new persistent data structure formats;
converting all persistent data structures into the old persistent data structure format;
applying an upgrade to a second next level of software that understands said old and new persistent data structure formats; and
converting all persistent data structures into the new persistent data structure format.

16. The program storage device of claim 15, wherein said persistent data structures comprise communication packet structures.

17. The program storage device of claim 16, wherein said software application comprises a distributed system software application including a plurality of nodes holding non-volatile memory data structures.

18. The program storage device of claim 17, wherein said nodes communicate with one another.

19. The program storage device of claim 18, wherein the communication between said nodes occurs using said communication packet structures.

20. The program storage device of claim 15, wherein said method further comprises:
applying a downgrade to a first previous level of software that understands both said old and new persistent data structure formats;
converting all persistent data structures into the old persistent data structure format; and
applying a downgrade to a second previous level of software that understands said old persistent data structure formats.
